(19) United States
(12) Patent Application Publication
(10) Pub. No.: US 2025/0011249 A1
(43) Pub. Date: Jan. 9, 2025

(54) ADHESION PROPERTIES OF CEMENT/EPOXY INTERFACE USING GRAPHENE-BASED NANOMATERIALS

(71) Applicant: KING FAHD UNIVERSITY OF PETROLEUM AND MINERALS, Dhahran (SA)

(72) Inventors: Ashraf Awadh BAHRAQ, Dhahran (SA); Mohammed Ali ALOSTA, Dhahran (SA); Ime Bassey OBOT, Dhahran (SA); Omar Saeed Baghabra AL-AMOUDI, Dhahran (SA); Tawfik Abdo Saleh AWADH, Dhahran (SA); Mohammed MASLEHUDDIN, Dhahran (SA)

(73) Assignee: KING FAHD UNIVERSITY OF PETROLEUM AND MINERALS, Dhahran (SA)

(21) Appl. No.: 18/347,998

(22) Filed: Jul. 6, 2023

(51) Int. Cl. C04B 41/52; C04B 41/00; C04B 41/48; C04B 41/50; C04B 41/63; C04B 41/65; C04B 41/71; C09D 1/00; C09D 5/00; C09D 7/61; C09D 7/63; C09D 163/00

(52) U.S. Cl. CPC C04B 41/522; C04B 41/009; C04B 41/4853; C04B 41/5001; C04B 41/63; C04B 41/65; C04B 41/71; C09D 1/00; C09D 5/002; C09D 7/61; C09D 7/63; C09D 163/00

(57) ABSTRACT

A method for enhancing adhesion of a curable composition to a cement-based object includes applying a graphene oxide (GO) containing dispersion on a surface of the cement-based object thereby forming a GO-treated surface on the cement-based object. The method includes disposing the curable composition on the GO-treated surface of the cement-based object. The method includes curing the curable composition by heating thereby forming a GO interfacial layer and an epoxy resin layer. The GO interfacial layer is between the surface of the cement-based object and the epoxy resin layer. The curable composition includes an epoxy monomer and an amine curing agent. The GO interfacial layer has a thickness of from 0.1 to 10 nanometers (nm).

### STATEMENT REGARDING PRIOR DISCLOSURE BY THE INVENTORS

Aspects of this technology are described in “Improving the adhesion properties of cement/epoxy interface using graphene-based nanomaterials: Insights from molecular dynamics simulation” published in Cement and Concrete Composites, Volume 134, 104801, which is incorporated herein by reference in its entirety.

### STATEMENT OF ACKNOWLEDGEMENT

This research was supported by the Deanship of Research Oversight & Coordination (DROC) at King Fahd University of Petroleum and Minerals (KFUPM) under the project number DF191009.

### BACKGROUND

### Technical Field

The present disclosure is directed to a method for enhancing adhesion of a curable composition to a cement-based object, and particularly, to the method for enhancing adhesion of a graphene (GR) containing composition to the cement-based object.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Epoxy-based polymers are widely employed in the construction industry as structural adhesives or protective coatings. For example, epoxy resins are utilized to bond fiber-reinforced polymer (FRP) sheets to a concrete substrate. However, the adhesive component plays a critical role in these repair systems, and its degradation or failure can result in a complete breakdown of the bonded system. There are several potential causes for such failures, including loss of material compatibility, poor installation practices, application of excessive loading, or exposure to harmful environmental factors. Among these, exposure to aggressive environments has been identified as the primary culprit, and preventive measures in this regard are often challenging to control. In this regard, reinforcing epoxy resins with advanced materials can enhance their mechanical and durability properties. One example is the incorporation of graphene-based nanomaterials. Graphene and its derivatives offer unique characteristics, such as a large specific surface area, mechanical stability, hydrophilic nature, superior mechanical properties, and relatively low production cost compared to other nanomaterials like carbon nanotubes.

The inclusion of graphene nanomaterials into a cement matrix may enhance the hydration process as well as the mechanical properties. Inclusion of GO into the cement mixture could increase the compressive and flexural strengths by 15-33% and 41-59%, respectively [Z. Pan, L. He, L. Qiu, A. H. Korayem, G. Li, J. W. Zhu, F. Collins, D. Li, W. H. Duan, M. C. Wang, Mechanical properties and microstructure of a graphene oxide-cement composite, Cem. Concr. Compos. 58 (2015) 140-147].

Molecular dynamics (MD) simulation is a promising technique for investigating material behavior at the atomic scale. Several studies have explored the use of MD simulation to examine the interaction between graphene and calcium silicate hydrate (C—S—H), which is the primary hydration product of ordinary Portland cement. Reactive force field MD methods were employed to study the incorporation of graphene oxide (GO) into C—S—H composites. In these simulations, the GO was functionalized by different functional groups, including hydroxyl (C—OH), epoxy (C—O—C), carboxyl (COOH), and sulfonic (SO₃H) groups. The simulation results showed that the GO/C—S—H nanocomposite exhibited improved interfacial cohesive strength and ductility when subjected to tensile loading. Hydrogen bonds were formed between the interlayer water molecules in C—S—H and functional hydroxyl groups in GO. The presence of these hydroxyl groups provided non-bridging oxygen (NBO) sites, which contributed to the enhanced interfacial bonding. Furthermore, the incorporation of graphene into the C—S—H matrix was found to enhance surface adhesion. Recent research has utilized a GO coating to strengthen the interface between polyethylene fiber and C—S—H. MD simulation results showed that the GO coating increased the stability of the interface and enhanced the interfacial bonding energy.

Regarding the epoxy/cement interface, the MD simulation may provide good insights into its adhesion properties. Specifically, the MD simulation focused on investigating the epoxy/C—S—H interface under the influence of moisture. The findings revealed that the presence of water molecules had a detrimental effect on the bond properties at the epoxy/C—S—H interface. This effect was attributed to the weakening of the Ca—O—Ca connections, which play a vital role in maintaining strong adhesion. The MD simulation highlighted that the water molecules interfered with these connections, ultimately reducing the overall adhesion strength. The effect of water and NaCl solution on the adhesion properties of an epoxy resin based on a diglycidyl ether of bisphenol-A (DGEBA) to C—S—H substrate was investigated by Wang et al. [P. Wang, Q. Yang, M. Wang, D. Hou, Z. Jin, P. Wang, J. Zhang, Theoretical investigation of epoxy detachment from C—S—H interface under aggressive environment, Constr. Build. Mater. 264 (2020) 120232]. Water molecules and aggressive ions progressively detached the epoxy from C—S—H surface. Epoxy/C—S—H under an aggressive environment containing water, NaCl, and Na₂SO₄ was also investigated. The MD simulation outcomes demonstrated that the Ca—O and hydrogen bonds (H-bonds) were weakened under the presence of water and ions. Furthermore, it was demonstrated that such connections were responsible for the epoxy/cement adhesion.

Moreover, graphene-based nanomaterials may offer a promising avenue for nano-modifying epoxy materials. Yu et al. [J. Yu, Q. Zheng, D. Hou, J. Zhang, S. Li, Z. Jin, P. Wang, B. Yin, X. Wang, Insights on the capillary transport mechanism in the sustainable cement hydrate impregnated with graphene oxide and epoxy composite, Compos. Part B. 173 (2019) 106907] described that the capillary transport mechanism of water and ions through the nanopores of C—S—H in the GO reinforced epoxy coating. The GO-epoxy composite mitigated the migration of water and ions in the C—S—H gel pore. Further, the H-bonds were formed between functional groups in the GO sheets and epoxy molecules. In another study, Hou et al. [D. Hou, Q. Yang, Z. Jin, P. Wang, M. Wang, X. Wang, Y. Zhang, enhancing interfacial bonding between epoxy and CSH using graphene oxide: An atomistic investigation, Appl. Surf. Sci. 568 (2021) 150896] investigated the enhancement of the bonding performance of EP/C—S—H by adding a GO layer at the interface. The H-bonds between epoxy and oxygen-containing functional groups of GO contributed to the enhancement bonding across the epoxy-GO interface. In addition, the inclusion of GO resulted in better resistance to pulling forces.

Although literature reveals numerous methods to reinforce cement matrix, there still exists a need to develop a method which may eliminate or overcome the aforementioned limitations, including inadequate bonding between the reinforcing material and the cement matrix, insufficient mechanical properties, suboptimal durability, or challenges in implementation. Additionally, the method preferably would enhance the durability and resistance of the cement matrix to various environmental conditions such as moisture, chemical exposure, and temperature fluctuations.

In view of the foregoing, one objective of the present disclosure is to describe a method for enhancing adhesion of a curable composition to a cement-based object. Another objective of the present disclosure is to provide a method for enhancing adhesion of a graphene (GR) containing composition to a cement-based object.

### SUMMARY

In an exemplary embodiment, a method for enhancing adhesion of a curable composition to a cement-based object is described. The method includes applying a graphene oxide (GO) containing dispersion on a surface of the cement-based object thereby forming a GO-treated surface on the cement-based object. The method includes disposing the curable composition on the GO-treated surface of the cement-based object. The method includes curing the curable composition by heating thereby forming a GO interfacial layer and an epoxy resin layer. In some embodiments, the GO interfacial layer is between the surface of the cement-based object and the epoxy resin layer. In some embodiments, the curable composition includes an epoxy monomer and an amine curing agent. In some embodiments, the GO interfacial layer has a thickness of from 0.1 to 10 nanometers (nm).

In some embodiments, the GO interfacial layer has a thickness of 0.2 to 2 nm.

In some embodiments, the GO interfacial layer has an oxygen coverage of 10 to 40% based on a total number of carbon atoms.

In some embodiments, the GO interfacial layer includes GO particles having one or more functional groups selected from the group consisting of epoxide (—O—), hydroxyl (—OH), and carboxyl (—COOH). The cement-based object includes hydrated calcium silicate (C—S—H) particles having one or more hydroxyl (—OH) groups.

In some embodiments, one or more hydrogen atoms in the hydroxyl groups of the hydrated calcium silicate (H_{CSH}) particles interact with one or more oxygen atoms of the epoxy resin layer (O_{EP}) and the GO interfacial layer (O_{GO}) resulting in the formation of one or more H_{CSH}—O_{EP} bonds and one or more H_{CSH}—O_{GO} bond.

In some embodiments, the one or more H_{CSH}—O_{EP} bonds have an average length of 1.95 to 2.05 angstroms (Å).

In some embodiments, the one or more H_{CSH}—O_{GO} bonds have an average length of 1.8 to 1.95 Å.

In some embodiments, one or more hydrogen atoms in the hydroxyl groups of the hydrated calcium silicate (H_{CSH}) particles interact with one or more carbon atoms of the GO interfacial layer (C_{GO}) resulting in the formation of one or more H_{CSH}—C_{GO} bonds.

In some embodiments, the one or more H_{CSH}—C_{GO} bonds have an average length of 3.5 to 3.6 Å.

In some embodiments, one or more oxygen atoms of the epoxy resin layer (O_{EP}) interact with one or more oxygen atoms of the GO interfacial layer (O_{GO}) resulting in the formation of one or more O_{EP}—O_{GO} bonds.

In some embodiments, the one or more O_{EP}—O_{GO} bonds have an average length of 3 to 3.1 Å.

In some embodiments, a mole ratio of the epoxy monomer to the amine curing agent is in a range of 5:1 to 1:1.

In some embodiments, after the curing the epoxy resin of the epoxy resin layer has a cross-linking degree of 60 to 95% based on a total number of the epoxy monomer and the amine curing agent.

In some embodiments, the epoxy monomer is a polyhydric phenol glycidyl ether. In some embodiments, the polyhydric phenol glycidyl ether includes diglycidyl ether bisphenol-A (DGEBA).

In some embodiments, the amine curing agent is a phenylenediamine. In some embodiments, the phenylenediamine includes m-phenylenediamine (m-PDA).

In some embodiments, a weight ratio of the GO interfacial layer to the epoxy resin layer is in a range of 1:200 to 1:10.

In some embodiments, the adhesion of the epoxy resin layer formed from the curable composition to the cement-based object is improved compared to that of an epoxy resin layer formed from a composition in the absence of the GO when exposed to a condition selected from the group consisting of a dry condition, a wet condition, and a salt-containing condition. In some embodiments, the epoxy resin layer has a water diffusion coefficient of 0.05×10⁻¹² to 0.09×10⁻¹² meter square per second (m²·s⁻¹), and the epoxy resin layer has a chloride ions diffusion coefficient of 0.04×10⁻¹² to 0.13×10⁻¹² m₂·s⁻¹.

In another exemplary embodiment, a method for enhancing adhesion of a graphene (GR) containing composition to a cement-based object. The method includes mixing an epoxy monomer, an amine curing agent, and a GR nanomaterial to form the GR-containing composition. The method further includes disposing the GR-containing composition on a surface of the cement-based object. Furthermore, the method includes curing the GR-containing composition by heating thereby forming a modified epoxy resin layer on the surface of the cement-based object. In some embodiments, the GR nanomaterial has a thickness of 0.2 to 1 nm. In some embodiments, the GR nanomaterial is present in the GR-containing composition at a concentration of 0.01 to 10 wt. % by weight.

In some embodiments, one or more hydrogen atoms in the hydroxyl groups of the hydrated calcium silicate (HCSH) particles of the cement-based object interact with one or more carbon atoms of the GR nanomaterial in the modified epoxy resin (CGR) resulting in the formation of one or more H_{CSH}—C_{GR} bonds.

In some embodiments, the one or more H_{CSH}—C_{GR} bonds have an average length of 2.5 to 2.6 Å.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method for enhancing adhesion of a curable composition to a cement-based object, according to certain embodiments;

FIG. 1B is a schematic flow chart of a method for enhancing adhesion of a graphene (GR) containing composition to the cement-based object, according to certain embodiments;

FIG. 2A depicts a simulation methodology for a model component, such as cross-linking epoxy procedure, according to certain embodiments;

FIG. 2B depicts a simulation methodology for a model component such as GR and graphene oxide (GO) built models, according to certain embodiments;

FIG. 2C depicts a simulation methodology for a model component such as graphene-modified epoxy coatings (GR-mEP and GO-mEP), according to certain embodiments;

FIG. 3A depicts a model construction of three systems (dry, wet, and salt), according to certain embodiments;

FIG. 3B depicts a model construction of different graphene-reinforcement schemes, according to certain embodiments;

FIG. 4 depicts radial distribution function (RDF) between carbon and nitrogen atoms (C—N) of the cross-linked epoxy (EP), according to certain embodiments;

FIG. 5A depicts work of adhesion of models such as reference model without graphene (M1), model with adding GR layer (M2), model with adding GO layer (M3), model with GR-modified epoxy (M4), and model with GO-modified epoxy (M5), according to certain embodiments;

FIG. 5B depicts normalized energy of the interaction components for dry models (original and reference condition) M1-M5, according to certain embodiments;

FIG. 5C depicts normalized energy of the interaction components for wet models (to simulate the pre-wetting surface condition) M1-M5, according to certain embodiments;

FIG. 5D depicts normalized energy of the interaction components for salt models (to simulate the NaCl solution), according to certain embodiments;

FIG. 6A depicts snapshots showing H-bond between hydrated calcium silicate (C—S—H) and epoxy atoms, according to certain embodiments;

FIG. 6B depicts RDF curves of H_{CSH}—O_{EP} pair, according to certain embodiments;

FIG. 7A depicts RDF curves of H_{CSH}—C_{GR} pair, according to certain embodiments;

FIG. 7B depicts RDF curves of H_{CSH}—C_{GO} pair, according to certain embodiments;

FIG. 7C depicts RDF curves of H_{CSH}—O_{GO} pair, according to certain embodiments;

FIG. 7D depicts RDF curves of O_{EP}—O_{GO} pair, according to certain embodiments;

FIG. 8 depicts interfacial atoms between C—S—H and GO (H-bond formation), according to certain embodiments;

FIG. 9A depicts dry model with GR/GO layer, according to certain embodiments;

FIG. 9B depicts salt model with GR/GO layer, according to certain embodiments;

FIG. 9C depicts dry model with modified epoxy, according to certain embodiments;

FIG. 9D depicts salt model with modified epoxy, according to certain embodiments;

FIG. 10A depicts intensity profile of the wet M1 model, according to certain embodiments;

FIG. 10B depicts intensity profile of the wet M2 model, according to certain embodiments;

FIG. 10C depicts intensity profile of the wet M3 model, according to certain embodiments;

FIG. 11A depicts molecular simulation dynamics (MSD) curves of H₂O particles inside the models M1-M5, according to certain embodiments;

FIG. 11B depicts MSD curves of Cl-particles inside the models M1-M5, according to certain embodiments;

FIG. 12A depicts penetration depth curves of H₂O particles inside the models M1-M5, according to certain embodiments; and

FIG. 12B depicts penetration depth curves of Cl-particles inside the models M1-M5, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

As used herein, the term ‘epoxide group’ refers to the group involving two carbons and oxygen forming a three-membered ring structure.

As used herein, the term ‘hydroxy or hydroxyl group’ refers to the functional group with the chemical formula-OH and composed of one oxygen atom covalently bonded to one hydrogen atom.

As used herein, the term ‘carboxyl group’ refers to the combination of two functional groups attached to a single carbon atom, namely, hydroxyl (OH) and carbonyl (O).

Aspects of the present disclosure are directed to a method for enhancing adhesion of a curable composition to a cement-based object. The curable composition has crosslinked epoxy, while the cement-based object has hydrated calcium silicate (C—S—H) particles, preferably a cured cement or cured concrete matrix. The interfacial properties between cross-linked epoxy and C—S—H are improved using graphene (GR) and graphene oxide (GO) nanomaterials. Different reinforcement schemes, such as adding the GR or GO layer and modifying the epoxy with GR or GO nanomaterials, are included.

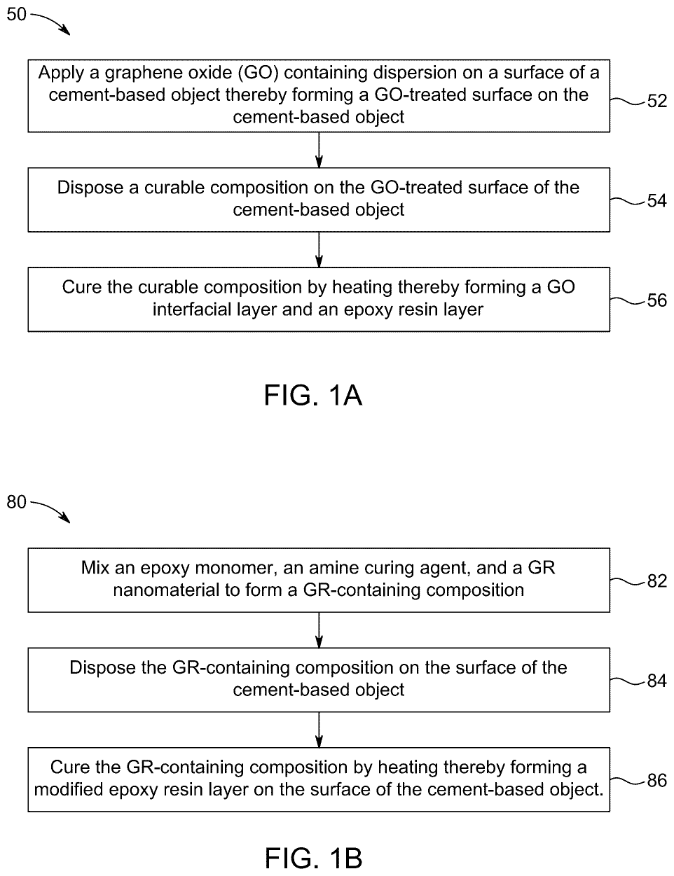

FIG. 1A illustrates a method 50 for enhancing adhesion of a curable composition to a cement-based object. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes applying a GO containing dispersion on a surface of the cement-based object thereby forming a GO-treated surface on the cement-based object. The GO containing dispersion can be applied to the surface of the cement-based object via one or methods such as brushing, spraying, dipping, and flow coating. In some embodiments, only one side of the cement-based object is treated by the GO containing dispersion. In an embodiment, the cement-based object is coated partially or wholly with at least one layer of the GO containing dispersion in a uniform and continuous manner. In some embodiments, the GO-containing dispersion covers at least 50% of the total surface area of the cement-based object, preferably at least 70%, preferably at least 90%, or even more preferably at least 99% based on the total surface area of the cement-based object. Other ranges are also possible. In a preferred embodiment, the GO containing dispersion forms a continuous layer on the cement-based object. Preferably, the GO present in the coating of the GO-treated surface on the cement-based object is the only GO and/or only GR material in the fully cured epoxy coated cement-based object, e.g., the graphene-based component is present only in the interlayer between the epoxy layer and the outer surface of the cement-based object. In an embodiment, particles of the GO containing dispersion form a monolayer on the cement-based object. In some embodiments, the monolayer has an average thickness of about 0.5 nm, about 1 nm, about 2 nm, or even more preferably about 5 nm. Other ranges are also possible. In another embodiment, particles of the GO containing dispersion may include more than a single layer on the cement-based object.

The GO particles present in the GO containing dispersion may exist in various morphological shapes, such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, and mixtures thereof. In some preferred embodiments, the GO particles are two-dimensional (2D) material.

In some embodiments, the cement-based object includes hydrated calcium silicate (C—S—H) particles having one or more hydroxyl (—OH) groups, preferably in a continuous matrix of cured cement or concrete. In some further embodiments, the cement-based object is made by at least one of a tobermorite-type calcium silicate-based material, a jennite-type calcium silicate-based material, a xonotlite-type calcium silicate-based material, a foshagite-type calcium silicate-based material, and a hillebrandite-type calcium silicate-based material. In some more preferred embodiments, the cement-based object may optionally be made by at least one of a hydrogarnet material, a hydrogrossular material, a hydrotalcite material, a katoite material, and a tacharanite. In some most preferred embodiments, the cement-based object is made a tobermorite-type calcium silicate-based material having a basal reflection of 11 Å. The tobermorite-type calcium silicate-based material has a crystalline structure with lattice parameters of 6.69 Å×7.39 Å×22.779 Å (a×b×c). Other ranges are also possible. In certain embodiments, the cement-based object may be prepared by mixing a tobermorite-type calcium silicate-based material and water to form a slurry and curing to form the cement-based object. A water-cement ratio by weight may be in a range of 0.4 to 0.6, or even more preferably about 0.5. Other ranges are also possible.

As used herein, “aggregate” refers to a broad category of particulate material used in construction. Aggregates are a component of composite materials such as concrete; the aggregates serve as reinforcement to add strength to the overall composite material. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small exposed pores to irregular with small to large exposed pores. Particle shape and surface texture of both fine and coarse aggregates may influence proportioning of mixtures in such factors as workability, pumpability, fine-to-coarse aggregate ratio, and water requirement.

The cement-based object may further include a fine aggregate (FA) in an amount of 5 to 40 wt. % based on the total weight of the cement-based object, preferably 10 to 30 wt. %, or even more preferably 20 wt. % based on the total weight of the cement-based object. In a preferred embodiment, the fine aggregate is sand, more preferably dune sand. As used herein, “sand” refers to a naturally occurring granular material composed of finely divided rock and mineral particles. It is defined by size in being finer than gravel and coarser than silt. The composition of sand varies, depending on the local rock sources and conditions, but the most common constituent of sand is silica (silicon dioxide, or SiO₂), usually in the form of quartz. In terms of particle size, sand particles range in diameter from 0.0625 mm to 2 mm. An individual particle in this range is termed a sand grain. By definition sand grains are between gravel (particles ranging from 2 mm to 64 mm) and silt (particles ranging from 0.004 mm to 0.0625 mm). In a most preferred embodiment, the fine aggregate of the cement-based object is dune sand with a specific gravity of 2.2-3.2, preferably 2.4-3.0, more preferably 2.5-2.7, or about 2.6.

The cement-based object may further include a coarse aggregate (CA) in an amount of 0.01 to 60 wt. % based on the total weight of the cement-based object, preferably 5 to 55 wt. %, preferably 10 to 45 wt. %, preferably 20 to 40 wt. %, or even more preferably about 30 wt. % based on the total weight of the cement-based object. In a preferred embodiment, the course aggregate present in the cement-based object is crushed limestone. As used herein, limestone refers to a sedimentary rock composed largely of the minerals calcite and aragonite, which are different crystal forms of calcium carbonate (CaCO₃). Limestone is naturally occurring and can be found in skeletal fragments of marine organisms such as coral, forams, and molluscs. Crushed limestone is generated during the crushing and grinding of limestone rocks. The crushed limestone used herein may have an average particle size greater than 1 mm. In one embodiment, the crushed limestone has an average particle size of 1.5-32 mm, preferably 2-30 mm, preferably 4-28 mm, preferably 6-24 mm, preferably 8-20 mm, preferably 10-18 mm, preferably 12-16 mm. The crushed limestone may contain materials including, but not limited to, calcium carbonate, silicon dioxide, quartz, feldspar, clay minerals, pyrite, siderite, chert and other minerals. In a most preferred embodiment, the coarse aggregate of the cement-based object is crushed limestone with a specific gravity of 2.1-3.0, preferably 2.2-2.8, more preferably 2.4-2.7, or about 2.56.

The cement-based object further includes a plasticizer in an amount of 0.001 to 2 wt. % based on the total weight of the cement-based object. The plasticizer includes at least one included from the group consisting of a lignosulfonate plasticizer, a polycarboxylate ether plasticizer, a melamine plasticizer, and a naphthalene plasticizer. In some embodiments, the plasticizer is a combination of two or more plasticizers selected from the above group. In some specific embodiments, the plasticizer is a combination of one or more plasticizers included from the above group with an organic non-volatile compound.

As used herein, a “plasticizer” is an additive that increases the plasticity or fluidity of slurry. Plasticizers increase the workability of “fresh” cement slurry, allowing it to be placed more easily, with less consolidating effort. A superplasticizer is a plasticizer with fewer deleterious effects. A “superplasticizer” refers a chemical admixture used herein to provide a well-dispersed particle suspension in the wet cement slurry. The superplasticizer may be used to prevent particle segregation and to improve the flow characteristics of the wet cement slurry. The superplasticizer may be a polycarboxylate, e.g. a polycarboxylate derivative with polyethylene oxide side chains, a polycarboxylate ether (PCE) superplasticizer, such as the commercially available Glenium 51®. Polycarboxylate ether superplasticizers may allow a significant water reduction at a relatively low dosage, thereby providing good particle dispersion in the wet concrete slurry. Polycarboxylate ether superplasticizers are composed of a methoxy-polyethylene glycol copolymer (side chain) grafted with methacrylic acid copolymer (main chain). Exemplary superplasticizers that may be used in addition to, or in lieu of a polycarboxylate ether superplasticizer include, but are not limited to, alkyl citrates, sulfonated naphthalene, sulfonated alkene, sulfonated melamine, lignosulfonates, calcium lignosulfonate, naphthalene lignosulfonate, polynaphthalenesulfonates, formaldehyde, sulfonated naphthalene formaldehyde condensate, acetone formaldehyde condensate, polymelaminesulfonates, sulfonated melamine formaldehyde condensate, polycarbonate, other polycarboxylates, other polycarboxylate derivatives comprising polyethylene oxide side chains, and the like and mixtures thereof. In a preferred embodiment, the cement slurry has a weight percentage of the plasticizer ranging from 0.1-3.0% relative to the total weight of the cement slurry, preferably 0.2-2.5%, preferably 0.5-2.0%, preferably 1.0-1.8%, preferably 1.2-1.6%, or about 1.5% relative to the total weight of the cement slurry. Other ranges are also possible.

In an embodiment, the cement-based object may further include a surfactant. In a preferred embodiment, the surfactant may be a nonionic surfactant, an anionic surfactant, a cationic surfactant, a viscoelastic surfactant, or a zwitterionic surfactant. The surfactants may include, but are not limited to, ammonium lauryl sulfate, sodium lauryl sulfate (SLS), sodium dodecyl sulfate (SDS), alkyl-ether sulfates sodium laureth sulfate (sodium lauryl ether sulfate (SLES), sodium myreth sulfate, docusate (dioctyl sodium sulfosuccinate), perfluorooctanesulfonate (PFOS), perfluorobutanesulfonate, alkyl-aryl ether phosphates, alkyl ether phosphates, octenidine dihydrochloride; cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), CHAPS (3-[(3-cholamidopropyl)dimethylammonio]-1-propanesulfonate), cocamidopropyl hydroxysultaine, ocamidopropyl betaine, phospholipids, and sphingomyelins. In a preferred embodiment, the cement slurry has a weight percentage of the surfactant ranging from 0.1-3.0% relative to the total weight of the composition, preferably 0.2-2.5%, preferably 0.5-2.0%, preferably 1.0-1.8%, preferably 1.2-1.6%, or about 1.5% relative to the total weight of the cement slurry. Other ranges are also possible.

The surfactant may include primary and secondary emulsifiers. Hereinafter, the primary and secondary emulsifiers are collectively referred to as the “emulsifiers” or “surfactants” and individually referred to as the “emulsifier” or “surfactant,” unless otherwise specified. The primary emulsifier is a polyaminated fatty acid. The primary emulsifier includes a lower hydrophilic-lyophilic balance (HLB) in comparison to the secondary emulsifier. The primary emulsifier may include, but are not limited to, span 60, span 85, span 65, span 40, and span 20. The primary emulsifier is sorbitan oleate, also referred to as the span 80. The secondary emulsifier may include, but are not limited to triton X-100, Tween™ 80, Tween™ 20, Tween™ 40, Tween™ 60, Tween™ 85, OP4 and OP 7. The secondary emulsifier includes a biosurfactant such as a rhamnolipid surfactant. In an embodiment, the surfactant may be neopelex or stearic acid.

The cement-based object may further include a defoaming agent. As used herein, the term “deforming agent” refers to the chemical additive that reduces and hinders foam formation in industrial process liquids. The deforming agent may include, but are not limited to, 2-octanol, oleic acid, paraffinic waxes, amide waxes, sulfonated oils, organic phosphates, silicone oils, mineral oils, and dimethylpolysiloxane. The defoaming agent may be dimethyl silicone polymer or polyoxy propylene glycerin ether. In a preferred embodiment, the cement slurry has a weight percentage of the defoaming agent ranging from 0.01-1.0% relative to the total weight of the composition, preferably 0.02-0.8%, preferably 0.03-0.6%, preferably 0.04-0.4%, preferably 0.05-0.2%, or about 0.1% relative to the total weight of the cement slurry.

In some embodiments, the GO containing dispersion may be prepared by dispersing graphite oxide in a solvent to form a graphite oxide dispersion and sonicating thereby exfoliating the graphite oxide sheets to form the GO containing dispersion. In some embodiments, the solvent includes at least one selected from the group consisting of water, N-methyl-2-pyrrolidone (NMP), dimethylformamide (DMF), dimethyl sulfoxide (DMSO), ethanol, methanol, and isopropyl alcohol (IPA). In some preferred embodiments, the solvent is water. In some preferred embodiments, the water is at least one selected from the group consisting of tap water, groundwater, distilled water, deionized water, freshwater, and desalted water. In some more preferred embodiments, the GO is present in the GO containing dispersion at a concentration of 0.1 to 1000 milligrams per liter (mg/L), preferably 0.5 to 500 mg/L, preferably 1 to 300 mg/L, preferably 5 to 100 mg/L, or even more preferably about 50 mg/L. Other ranges are also possible. In yet some other embodiments, the GO containing dispersion may be prepared by other methods known to those skilled in the art.

In some embodiments, the surface of the cement-based object may be pre-treated before applying the GO containing dispersion. In some embodiments, the surface of the cement-based object may be cleaned to ensure optimal adhesion. The presence of any substances that could potentially interfere with adhesion, such as dust, dirt, oil, or curing compounds, should be effectively removed. This can be achieved by employing cleaning methods such as sweeping or vacuuming, or any other methods known to those skilled in the art. As used herein, the term “sweeping” generally refers to a process of sweeping the surface to remove loose particles and debris. In the present disclosure, the term “sweeping” includes using a scrub brush or suitable cleaning tool to gently agitate the surface and facilitate the removal of particles. In certain embodiments,

In certain embodiments, the method for enhancing the adhesion of cement-epoxy systems may be applied to hardened cement-based object surfaces, aged cement-based object surfaces, and/or uncoated cement-based object. In some embodiments, the surface of the cement-based object after pre-treatment may have a less rough surface morphology. As used herein, the term “rough surface” or “rough surface morphology” generally refers to the physical characteristics or features of a surface that deviate from smoothness or regularity. The term “rough surface morphology” may include unevenness, irregularities, and variations in height, shape, or texture of a surface at a micro or macro scale. In the present disclosure, the rough surface morphology of the pre-treated cement-based object includes, but is not limited to, bumps, ridges, valleys, peaks, or irregular shapes that may be randomly distributed or organized in a specific pattern. Additionally, the surface roughness may be determined by roughness average (Ra), root mean square (RMS) roughness, or peak-to-valley height. Roughness average (Ra) is calculated by averaging the surface roughness of at least 5, and preferably at least 10, representative locations spaced approximately evenly across the portion of the pre-treated cement-based object. In some embodiments, it is preferred to measure the thickness at representative points across the longest dimension of the portion of the pre-treated cement-based object. The standard deviation of roughness is found by calculating the standard deviation of the local average roughness across at least 5, and preferably at least 10, representative locations spaced approximately evenly across the portion of the pre-treated cement-based object. In some embodiments, the cement-based object after pre-treatment may have a Ra of 0.5 to 10 μm, preferably 1 to 8 μm, preferably 2 to 6 μm, or even more preferably 3 to 4 μm. Other ranges are also possible.

At step 54, the method 50 includes disposing the curable composition on the GO-treated surface of the cement-based object. The curable composition includes an epoxy monomer (also referred to as the epoxy resin) and an amine curing agent. In an embodiment, the epoxy resin may include, but is not limited to, a bisphenol A epoxy resin, a bisphenol F epoxy resin, a novolak epoxy resin, an aliphatic epoxy resin, a glycidylamine epoxy resin, an epoxidized vegetable oil, and a mixture thereof. Certain other examples of the epoxy resin include polyglycidyl ethers of polyhydric phenols, for example, polyglycidyl ethers of bisphenol A, bisphenol F, bisphenol AD, catechol, and resorcinol. Epoxy compounds obtained by reacting polyhydric alcohols, such as butinediol or polyethylene glycol, or glycerin with epichlorohydrin, are also suitable. Epoxidized (poly) olefinic resins, epoxidized phenolic novolac resins, epoxidized cresol novolac resins, and cycloaliphatic epoxy resins may also be used. Urethane-modified epoxy resins are also suitable. Other suitable epoxy compounds include polyepoxy compounds based on aromatic amines and epichlorohydrin, such as N, N′-diglycidyl-aniline, N,N′-dimethyl-N,N′-diglycidyl-4,4′diaminodiphenyl methane, N,N,N′,N′-tetraglycidyl-4,4′diaminodiphenyl methane, N-diglycidyl-4-aminophenyl glycidyl ether, N,N,N′,N′-tetraglycidyl-1,3-propylene bis-4-aminobenzoate, and/or combinations thereof. In some embodiments, a mixture of epoxy resins may be used to prepare the mixture. In an embodiment, the epoxy monomer is a polyhydric phenol glycidyl ether. In some more preferred embodiments, the polyhydric phenol glycidyl ether is diglycidyl ether bisphenol-A (DGEBA).

The amine curing agent may include, but is not limited to, ethylenediamine, diethylenetriamine, triethylenetetramine, tetraethylenepentamine, and cycloaliphatic amines such as piperidine, N-aminoethylpiperazine (AEP), menthanediamine, and m-xylylenediamine (MXDA). In an embodiment, the amine curing agent is a phenylenediamine. In a preferred embodiment, the phenylenediamine is m-phenylenediamine (m-PDA). A mole ratio of the epoxy monomer to the amine curing agent is in a range of 5:1 to 1:1, preferably 4:1 to 2:1, or even more preferably about 3:1. Other ranges are also possible.

At step 56, the method 50 includes curing the curable composition by heating thereby forming a GO interfacial layer and an epoxy resin layer. In certain embodiments, a weight ratio of the GO interfacial layer to the epoxy resin layer is in a range of 1:200 to 1:10, preferably 1:180 to 1:20, preferably 1:160 to 1:30, preferably 1:140 to 1:40, preferably 1:120 to 1:50, preferably 1:100 to 1:60, or even more preferably 1:80 to 1:70. Other ranges are also possible. The GO interfacial layer is between the surface of the cement-based object and the epoxy resin layer and plays a role in the chemical bond between C—S—H and epoxy overlay (i.e., strengthening the interfacial adhesion properties). The thickness of the GO interfacial layer is related to the single atomic layer of carbon (approximately 1.0 nanometers (nm)). The thickness of the GO interfacial layer plays an important role in the adhesion properties. In a preferred embodiment, the GO interfacial layer has a thickness of from 0.1 to 10 nm, more preferably 0.2 to 2 nm, or even more preferably 0.5 to 1 nm. Other ranges are also possible. In certain embodiments, the GO interfacial layer has an oxygen coverage of 10 to 40% based on the total number of carbon atoms in the GO interfacial later, preferably 15 to 35%, preferably 20 to 30%, or even more preferably about 25% based on the total number of carbon atoms in the GO interfacial later. Other ranges are also possible.

As used herein, the term “oxygen coverage” generally refers to the proportion or extent of the surface area of a material that is occupied by oxygen atoms or oxygen-containing functional groups. In the present disclosure, the term “oxygen coverage” of the graphene oxide (GO) specifically refers to the amount or density of oxygen atoms or oxygen-containing groups bonded to the carbon lattice of the graphene structure. In certain embodiments, the density or percentage of oxygen atoms or oxygen-containing groups relative to the total number of carbon atoms in the GO may be determined or quantified by various analytical techniques, such as elemental analysis, Fourier-transform infrared spectroscopy (FTIR), X-ray photoelectron spectroscopy (XPS), or thermogravimetric analysis (TGA).

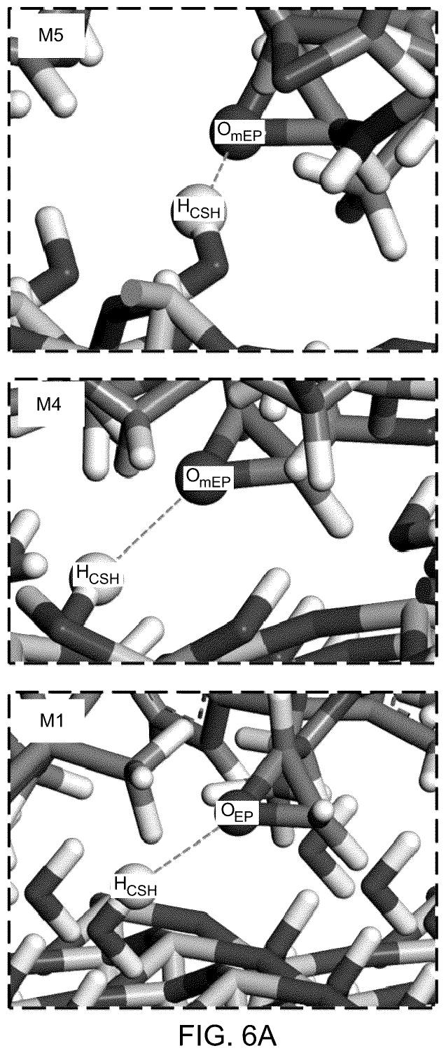

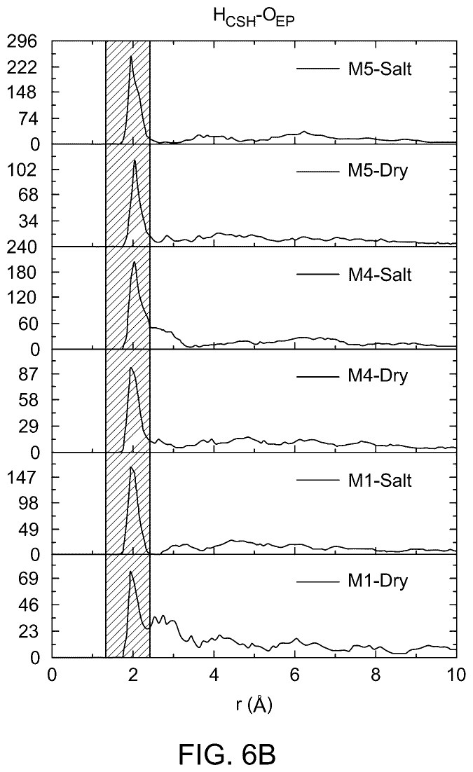

In some embodiments, the GO interfacial layer includes GO particles having one or more functional groups selected from the group consisting of epoxide (—O—), hydroxyl (—OH), and carboxyl (—COOH). One or more hydrogen atoms in the hydroxyl groups of the hydrated calcium silicate (H_{CSH}) particles interact with one or more oxygen atoms of the epoxy resin layer (O_{EP}) and the GO interfacial layer (O_{GO}), resulting in the formation of one or more H_{CSH}—O_{EP} bonds and one or more H_{CSH}—O_{GO} bond. Referring to FIG. 6A, H-bond between hydrated calcium silicate (C—S—H) and epoxy atoms, and FIG. 6B, the RDF curves of H_{CSH}—O_{EP} pair. In some embodiments, the H_{CSH}—O_{EP} bonds have an average length of 1.95 to 2.05 angstroms (Å), preferably 1.97 to 2.03 Å, or even more preferably 1.99 to 2.01 Å. In some embodiments, the H_{CSH}—O_{GO} bonds have an average length of 1.8 to 1.95 Å, preferably 1.82 to 1.93 Å, preferably 1.84 to 1.91 Å, preferably 1.86 to 1.89 Å, or even more preferably about 1.87 Å. Other ranges are also possible.

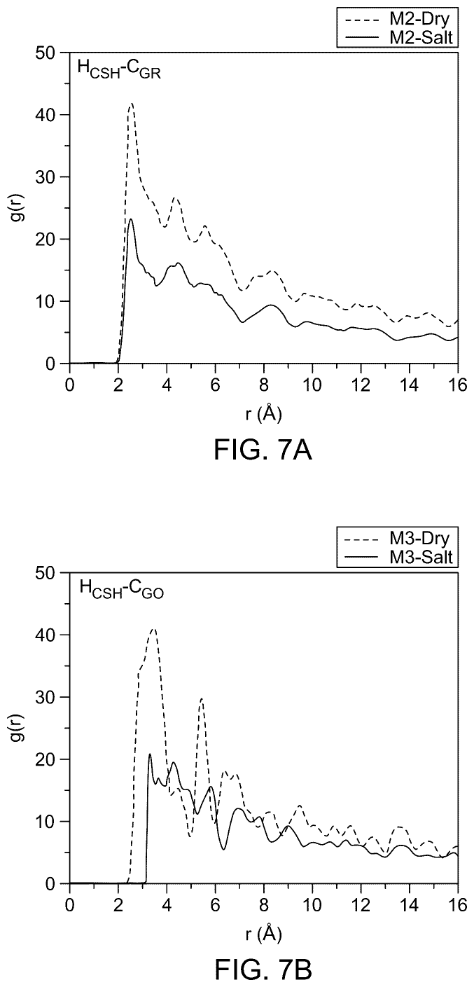

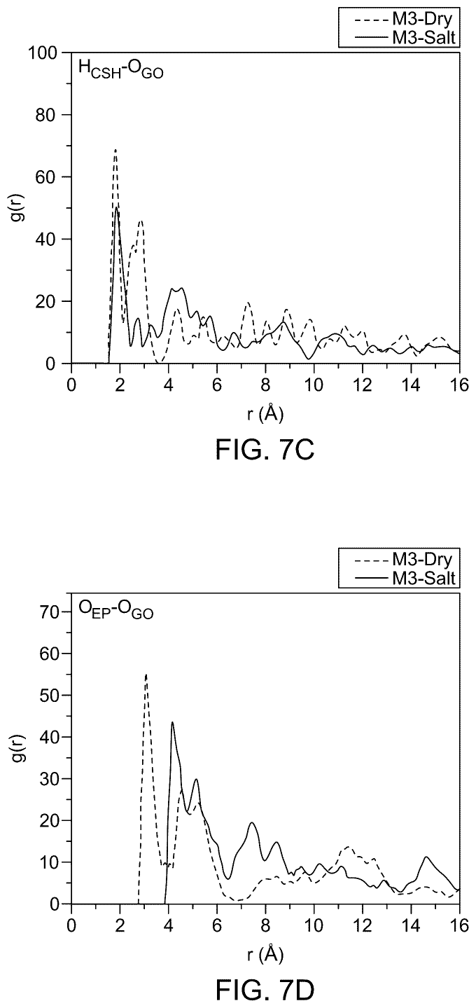

In some embodiments, one or more hydrogen atoms in the hydroxyl groups of the hydrated calcium silicate (H_{CSH}) particles interact with one or more carbon atoms of the GO interfacial layer (C_{GO}), resulting in the formation of one or more H_{CSH}—C_{GO} bonds. Referring to FIG. 7B, the RDF curves of H_{CSH}—C_{GO} pair. The H_{CSH}—C_{GO} bonds have an average length of 3.5 to 3.6 Å, preferably 3.51 to 3.59 Å, preferably 3.52 to 3.58 Å, preferably 3.53 to 3.57 Å, or even more preferably 3.54 to 3.56 Å. Other ranges are also possible. In some embodiments, one or more oxygen atoms of the epoxy resin layer (O_{EP}) interact with one or more oxygen atoms of the GO interfacial layer (O_{GO}) resulting in the formation of one or more O_{EP}—O_{GO} bonds. In some embodiments, the O_{EP}—O_{GO} bonds have an average length of 3 to 3.1 Å, preferably 3.02 to 3.08 Å, preferably 3.04 to 3.06 Å, or even more preferably about 3.05 Å. Other ranges are also possible.

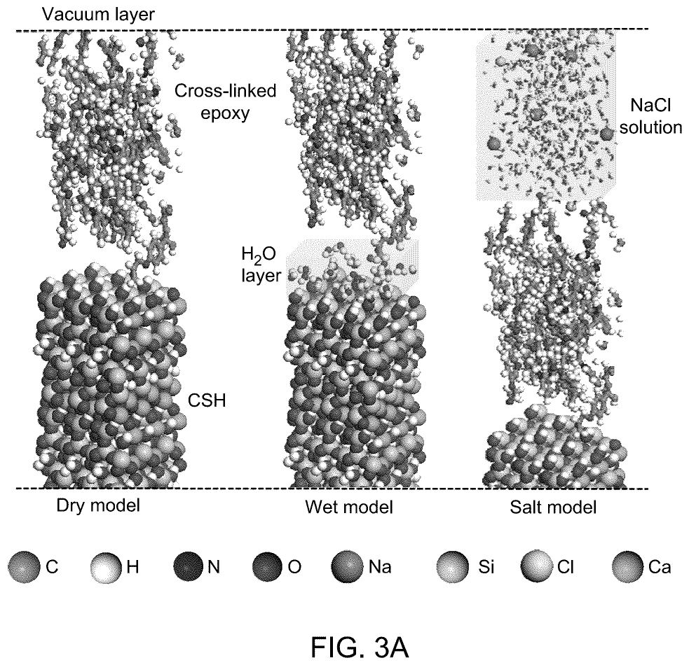

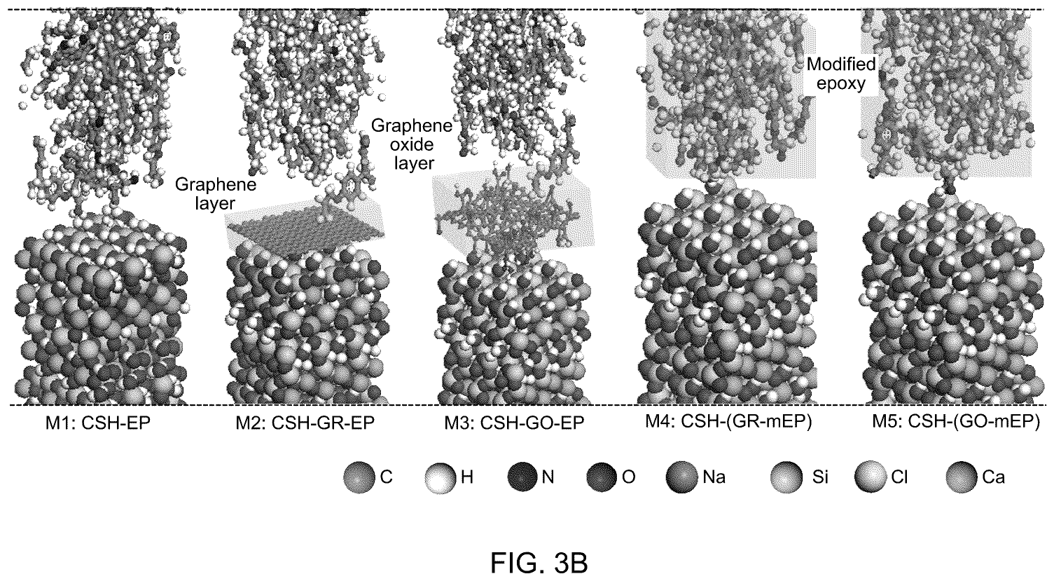

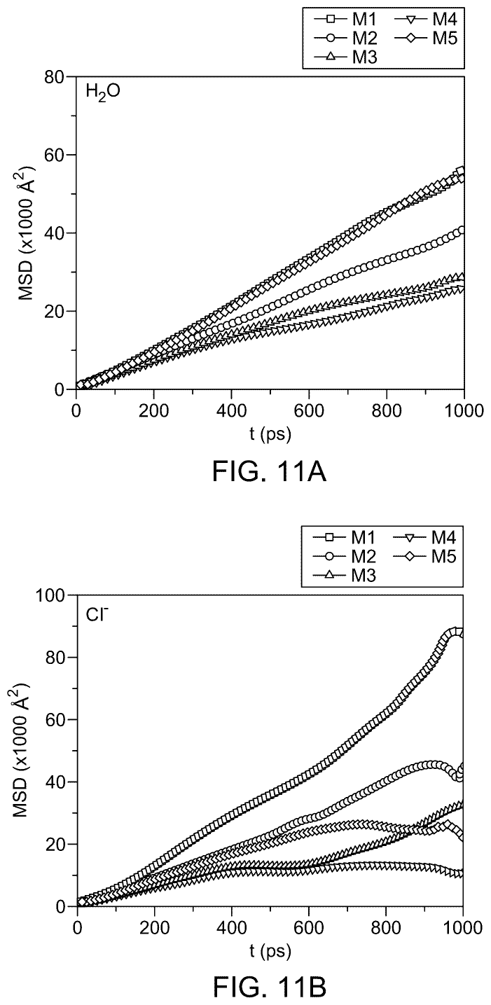

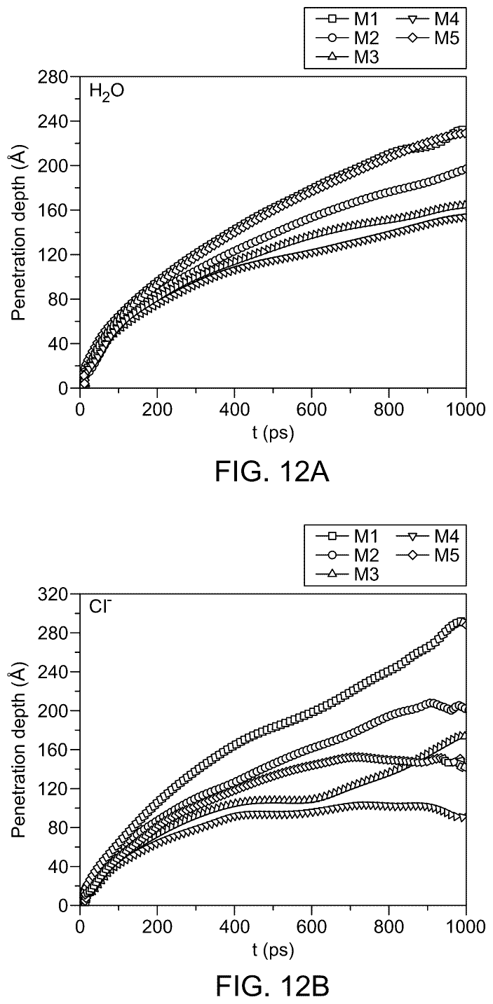

After curing, the epoxy resin of the epoxy resin layer has a cross-linking degree of 60 to 95% based on the total number of the epoxy monomer and the amine curing agent, preferably about 65 to 90%, preferably about 70 to 85%, or even more preferably 75 to 80% based on the total number of the epoxy monomer and the amine curing agent. The adhesion of the epoxy resin layer formed from the curable composition to the cement-based object is improved compared to that of an epoxy resin layer formed from a composition in the absence of the GO when exposed to a condition selected from the group consisting of a dry condition, a wet condition, and a salt-containing condition, as depicted in FIG. 3A. Referring to FIGS. 11A and 12A, in some embodiments, the epoxy resin layer has a water diffusion coefficient of 0.01×10⁻¹² to 0.1×10⁻¹² meter square per second (m²·s⁻¹), preferably 0.03×10⁻¹² to 0.08×10⁻¹², or even more preferably about 0.053×10⁻¹² m²·s⁻¹, as depicted in FIGS. 11A and 12A. Other ranges are also possible.

Referring to FIGS. 11B and 12B, in some more preferred embodiments, the epoxy resin layer has a chloride ions diffusion coefficient of 0.01×10⁻¹² to 0.2×10⁻¹² m²·s⁻¹, preferably 0.03×10⁻¹² to 0.15×10⁻¹² m²·s⁻¹, preferably 0.05×10⁻¹² to 0.1×10⁻¹² m²·s⁻¹, or even more preferably about 0.041×10⁻¹² m²·s¹, as depicted in FIGS. 11B and 12B. Other ranges are also possible. As described herein, the term “diffusion coefficient (D)” generally refers to the amount of a particular substance that diffuses across a unit area in 1 second under the influence of a gradient of one unit.

As used herein, the term “dry condition,” or “dry model” generally refers to the surface of the cement-based object is free from moisture or liquid. In the present disclosure, the dry condition indicates that there is no presence of water, humidity, or any other form of liquid on the surface.

As used herein, the term “wet condition,” or “wet model” generally refers to that there is water, humidity, or some form of liquid present on the surface of the cement-based object. In the present disclosure, the wet condition may be quantified by the moisture content of the cement surface which refers to the amount of unbound or excess water within the cement material. In some embodiments, the moisture content on the surface of the cement-based object is no more than 20 wt. %, no more than 15 wt. %, no more than 10 wt. %, no more than 5 wt. %, no more than 3 wt. %, no more than 1 wt. %, or even more preferably no more than 0.5 wt. % based on a total weight of a cement sample, as determined by an oven drying method, a calcium carbide method, and a Near-infrared (NIR) spectroscopy.

As used herein, the term “salt-containing condition,” or “salt-containing model” generally refers to that there is salt molecules present on the surface of the cement-based object. In the present disclosure, the salt present in the salt-containing condition is at least one of a sodium salt, a potassium salt, a calcium slat, and a magnesium salt. In an embodiment, the salt is sodium chloride. In a preferred embodiment, the sodium chloride is present in the salt-containing condition at a concentration of 0.1 to 5 mol/L, preferably 0.5 to 3 mol/L, or even more preferably about 1 mol/L.

FIG. 1B illustrates a method 80 for enhancing adhesion of a GR containing composition to the cement-based object. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes mixing the epoxy monomer, the amine curing agent, and a GR nanomaterial to form the GR-containing composition. In an embodiment, the epoxy monomer is a polyhydric phenol glycidyl ether. In a preferred embodiment, the polyhydric phenol glycidyl ether is diglycidyl ether bisphenol-A (DGEBA). In certain embodiments, the amine curing agent may include, but are not limited to, ethylenediamine, diethylenetriamine, triethylenetetramine, tetraethylenepentamine, and cycloaliphatic amines such as piperidine, N-aminoethylpiperazine (AEP), menthanediamine, and m-xylylenediamine (MXDA). In an embodiment, the amine curing agent is a phenylenediamine. In a preferred embodiment, the phenylenediamine is m-phenylenediamine (m-PDA). In some embodiments, a mole ratio of the epoxy monomer to the amine curing agent is in a range of 5:1 to 1:1, preferably 4:1 to 2:1, or even more preferably about 3:1. Other ranges are also possible.

In some embodiments, GR nanomaterial is present in the GR-containing composition at a concentration of 0.1 to 10 wt. % based on a total weight of the GR-containing composition, preferably 0.5 to 8 wt. %, preferably 1 to 6 wt. %, preferably 1.5 to 4 wt. %, or even more preferably about 2 wt. % based on the total weight of the GR-containing composition. Other ranges are also possible.

In some embodiments, the epoxy monomer, the amine curing agent, and the GR nanomaterial are mixed via any mode known to those of ordinary skill in the art, for example, via stirring, swirling, sonication. In some preferred embodiments, the GR nanomaterial has a thickness of 0.05 to 10 nm, preferably 0.1 to 5 nm, or even more preferably 0.2 to 1 nm. Other ranges are also possible. The GR nanomaterial may exist in various morphological shapes, such as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanofloweres, and mixtures thereof.

At step 84, the method 80 includes disposing the GR-containing composition on the surface of the cement-based object. The GR-containing composition can be applied to the surface of the cement-based object via known methods such as brushing, spraying, dipping, and flow coating. After applying the GR-containing composition, the cement-based object is dried to a temperature range of 20-40° C., or more preferably 25-30° C. The cement-based object may be dried by using heating appliances such as ovens, microwaves, autoclaves, hot plates, heating mantles and tapes, oil baths, salt baths, sand baths, air baths, hot-tube furnaces, and hot-air guns.

At step 86, the method 80 includes curing the GR-containing composition by heating thereby forming the modified epoxy resin layer on the surface of the cement-based object. The hydrogen atoms in the hydroxyl groups of the hydrated calcium silicate (H_{CSH}) particles of the cement-based object interact with one or more carbon atoms of the GR nanomaterial in the modified epoxy resin (C_{GR}), resulting in the formation of one or more H_{CSH}—C_{GR} bonds. Referring to FIG. 7A, the RDF curves of H_{CSH}—C_{GR} pair. The H_{CSH}—C_{GR} bonds have an average length of 2.5 to 2.6 Å, preferably 2.52 to 2.58 Å, preferably 2.54 to 2.56 Å, or even more preferably about 2.55 Å. Other ranges are also possible.

Referring to FIG. 3B, a cement reinforcement method includes at least one of an epoxy resin coated cement-based object (CSH-EP), a graphene interfacial layer/epoxy resin coated cement-based object (CSH-GR-EP), a graphene oxide interfacial layer/epoxy resin coated cement-based object (CSH-GO-EP), a graphene modified epoxy resin coated cement-based object (CSH-(GR-mEP)), and a graphene oxidemodified epoxy resin coated cement-based object (CSH-(GO-mEP)). In some embodiments, the CSH-GR-EP and the CSH-GO-EP may be prepared according to the method 50 of the present disclosure. In some further embodiments, the CSH-(GR-mEP) and the CSH-(GO-mEP) may be prepared according to the method 80 of the present disclosure.

The method of the present disclosure shows that inserting a GO sheet in the epoxy/C—S—H interface enhances its adhesion energy as the oxygen-containing functional groups in the GO provided more tight-binding patterns with the C—S—H surface as well as the epoxy overlay. On the other hand, modifying the epoxy by GR nanosheet also increases the adhesion energy due to its proper orientation inside the epoxy matrix. Moreover, the adopted graphene reinforcement method effectively mitigates the diffusion of water molecules and chloride ions. The sustainability and durability of the epoxy-bonded concrete systems is enhanced by the method of the present disclosure.

### EXAMPLES

The following examples describe and demonstrate exemplary embodiments of the method 50 for enhancing adhesion of a curable composition to a cement-based object described herein. The examples are provided solely for the purpose of illustration and are not to be construed as limitations of the present disclosure, as many variations thereof are possible without departing from the spirit and scope of the present disclosure.

### Example 1: Model Construction

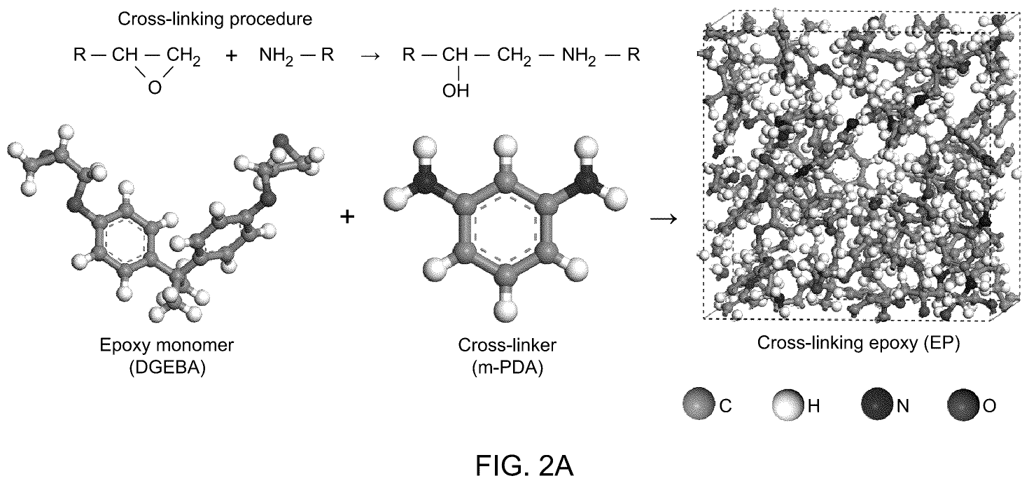

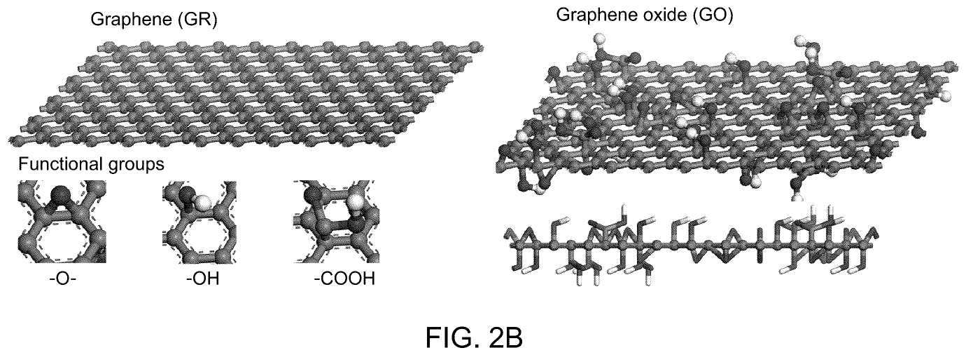

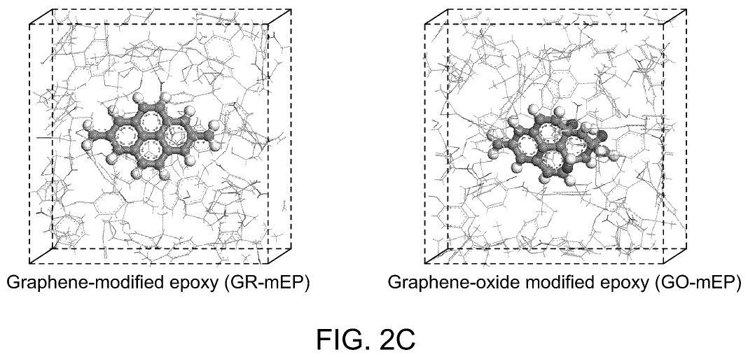

A mineral of 11 Å tobermorite was used to construct the C—S—H structure. The initial configuration of this structure is based on a spacing of ˜11 Å with lattice parameters of 6.69 Å×7.39 Å×22.779 Å (a×b×c). This structure has been used in many simulation studies. The C—S—H surface was obtained by cleaving the structure along [0 0 1] direction. Following, the cleaved surface was relaxed using geometry optimization and molecular dynamics. Then, a supercell of size 20.196 Å×20.196 Å was built to provide a large surface for the interaction with the epoxy. The reliability of the adopted model was judged by its mechanical properties. The diglycidyl ether bisphenol-A (DGEBA) was used as a resin epoxy, and m-phenylenediamine (m-PDA) was utilized as a curing agent. The cross-linking procedure was performed by a procedure as depicted in FIG. 2A. Firstly, the reactive atoms in the epoxy resin and crosslinker were identified. Then, the C—O—C bonds were broken, and the cross-linking reaction was done by forming a connection between open epoxy groups and cross-linkers, while the unreacted atoms were modified by hydrogen atoms. A total of 15 epoxy monomers of DGEBA and 10 cross-linkers of m-PDA were employed under a temperature of 300 kelvin (K). The reactive radius was set in the range of 3-10 Å with an interval of 0.5 Å. The cross-linking degree of achieving epoxy matrix was 80%. The size of the cross-linked epoxy (EP) is 20.83 Å×20.83 Å×20.83 Å.

The graphene monolayer was built from the graphite crystal having a unit cell of 2.459 Å×2.459 Å×6.800 Å (a×b×c). Then, the GR layer was replicated along the x- and y-directions to match the C—S—H substrate size. The GO was constructed by attaching three different functional groups, namely epoxide (—O—), hydroxyl (—OH), and carboxyl (—COOH), as shown in FIG. 2B. The oxygen coverage of the functionalized GO is about 25%, which is consistent with the typical functional group coverage of GO. Then, the cross-linked epoxy may be reinforced by using graphene derivatives (GR or GO). The GR and GO, with weight fractions of 3.4% and 4.6%, respectively, were embedded in the epoxy matrix to obtain graphene-modified epoxy (mEP) coatings, denoted hereafter as GR-mEP and GO-mEP, as depicted in FIG. 2C. The adopted graphene concentrations were selected based on the work reported by Rahman and Haque [R. Rahman, A. Haque, Molecular modeling of crosslinked graphene-epoxy nanocomposites for characterization of elastic constants and interfacial properties, Compos. Part B Eng. 54 (2013) 353-364, which is incorporated herein by reference in its entirety].

Three types of systems were constructed, including dry, wet, and salt. FIGS. 3A-3B display systems with the adopted different graphene-reinforcement schemes. The dry system is considered original without any exposure condition and thus treated as a reference model. In the wet system, a layer of water was inserted above the C—S—H surface, representing 3% moisture content. This was done to study the effect of the surface's pre-wetting on the adhesion properties of the epoxy/C—S—H interface. To investigate the effect of the aggressive environment on the interfacial behavior of the epoxy/cement system, a NaCl solution was added with a composition of 500 H₂O, 5 Na⁺, and 5 Cl⁻ and a density of 1.0 gram per cubic centimeter (g/cm³). This composition barely simulated the 1.0 mole per liter (mol/L) of NaCl solution. The effect of different graphene reinforcement configurations was investigated (FIG. 3B). These include the reference model without graphene (M1); model with adding GR layer (M2); model with adding GO layer (M3); model with GR-modified epoxy (M4); and model with GO-modified epoxy (M5). Therefore, a total of 15 models were built (five models for each system of dry, wet, and salt). For example, the reference dry model (M1-dry) consisted of two layers: C—S—H surface and cross-linked epoxy, while M2 is a tri-layer model (C—S—H, GR layer, and EP). Periodic boundary condition (PBC) was applied in all models. A vacuum layer of 40 Å was added in the z-direction while a large enough layer (˜ 80 Å) was set in the salt models to prevent the solution from being interacting with the C—S—H surface.

### Example 2: Materials and Software

M1 to M5 were evaluated using materials studio software [Biovia Software Inc., Biovia Materials Studio, (2019)]. The COMPASS [H. Sun, COMPASS: An ab initio force-field optimized for condensed-phase applications—Overview with details on alkane and benzene compounds, J. Phys. Chem. B. 102 (1998) 7338-7364, which is incoporated herein by reference in its entirety] and Dreiding [S. L. Mayo, B. D. Olafson, W. A. Goddard, DREIDING: A generic force field for molecular simulations, J. Phys. Chem. 94 (1990) 88978909, which is incorporated herein by reference in its entirety] force fields were adopted in the present disclosure. The COMPASS force field is an ab initio force field, and it has a wide coverage of research subjects. It has been successfully used in simulating cement-based materials. The Dreiding force field is a good robust all-purpose force field, and it is also shown capable of describing the interactions of polymers with graphene. The non-bonding terms, including electrostatic and van der Waals interaction energies, are included in both force fields. The amorphous cell module was used to construct the epoxy cells as well as NaCl solution. Initially, the components of each model were geometrically optimized using the Smart algorithm. The unmodified and modified epoxy coatings were then experienced an annealing procedure to randomize the distribution of the input molecules. This was done by heating the system from 298 K to 798 K and then cooling it from 798 K to 298 K. Following, relaxing dynamics under canonical ensemble (NVT ensemble) at 298 K for 200 ps was employed in the epoxy cells. The surface was constrained after constructing the interface models, followed by geometry optimization. The Forcite module was used to perform two-steps dynamics for 500 ps (as an equilibration run) and additional 1000 ps (as a production run) under the NVT with a time step of 1.0 fs. The runs were performed at room temperature (298 K) and controlled by the Nose thermostat [S. Nosé, A molecular dynamics method for simulations in the canonical ensemble, Mol. Phys. An Int. J. Interface Between Chem. Phys. 52 (1984) 255-268, which is incorporated herein by referene in its entirety]. The electrostatic and van der Waals interactions were calculated using the Ewald and atom-based summation methods. A cutoff distance with a buffer width of 12.5 Å and 0.5 Å, respectively, were adopted.

### Example 3: Model Characterization

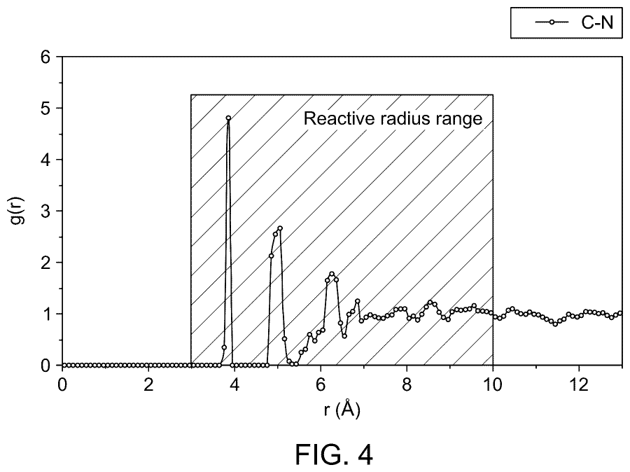

The adopted C—S—H was validated through Young's modulus (E). The calculated E of the C—S—H was 111.30 gigapascals (GPa), which agrees with experimental and simulation studies having 77.0-129.7 GPa. In addition, the cross-linked epoxy was also validated through E and density (φ. The values of E and ρ were found to be 3.27 GPa and 1.14 g/cm³, which are in line with the experimental and simulated data (E=2.70-4.02 GPa and p=1.07-1.34 g/cm³) [D. Hou, Q. Yang, P. Wang, Z. Jin, M. Wang, Y. Zhang, X. Wang, Unraveling disadhesion mechanism of epoxy/CSH interface under aggressive conditions, Cem. Concr. Res. 146 (2021) 106489, which is incorporated herein by reference in its entirety]. The radial distribution function (RDF) of the C—N pairs of the cross-linked epoxy was also obtained to confirm the selected reactive radius range of 3-10 Å. As shown in FIG. 4, the first peak is located at a distance of 3.75 Å where before this value, the g(r) equals zero, implying that no connection between C and N atoms can be formed. Then, the curve started to diminish and fluctuate around g(r) of 1.0 at a distance larger than 9 Å, as shown in FIG. 4. Besides, Young's moduli of the modified epoxy coatings were also calculated. The E values of the GR-mEP and GO-mEP were found to be 5.16 GPa and 3.98 GPa, respectively, indicating a corresponding increase of 58% and 22% were achieved compared to the unmodified epoxy coating.

### Example 4: Adhesion Energy

The interaction energy between the C—S—H substrate and the epoxy matrix was determined according to Eq. (1). All the calculations are single-point energies. The obtained values of the interaction energy are negative, suggesting that the epoxy is binding to the C—S—H surface. Then, the work of adhesion was calculated based on Eq. (2).

$$\begin{matrix}{E}_{int} = {E}_{Total} - ( {E}_{CSH} + {E}_{EP} ) & ( 1 ) \\ {W}_{adhesion} = \frac{{E}_{int}}{A} & ( 2 )\end{matrix}$$

where: Eᵢₙₜ is the interaction energy between C—S—H and epoxy; E_{Total} is the total energy of the system; E_{CSH} is the energy of the C—S—H only; E_{EP} is the energy of the epoxy only; W_{adhesion} is the work of adhesion, and A is the interface contact area.

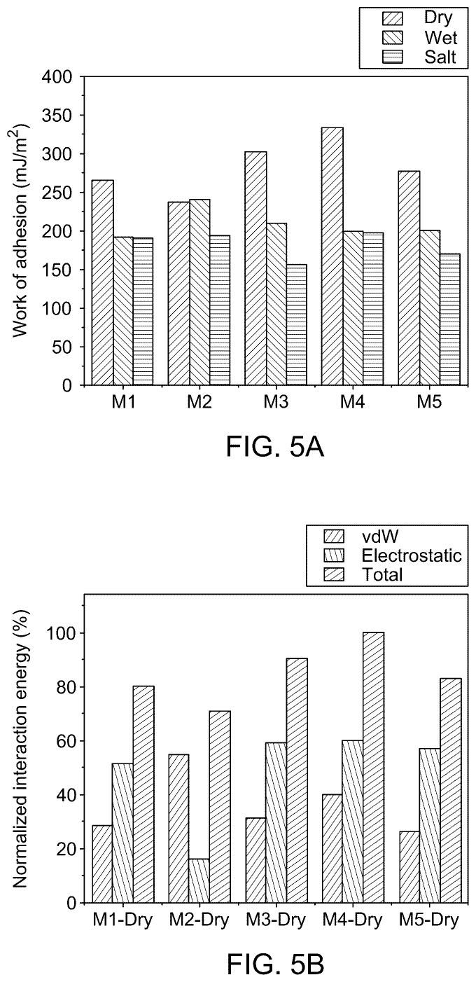

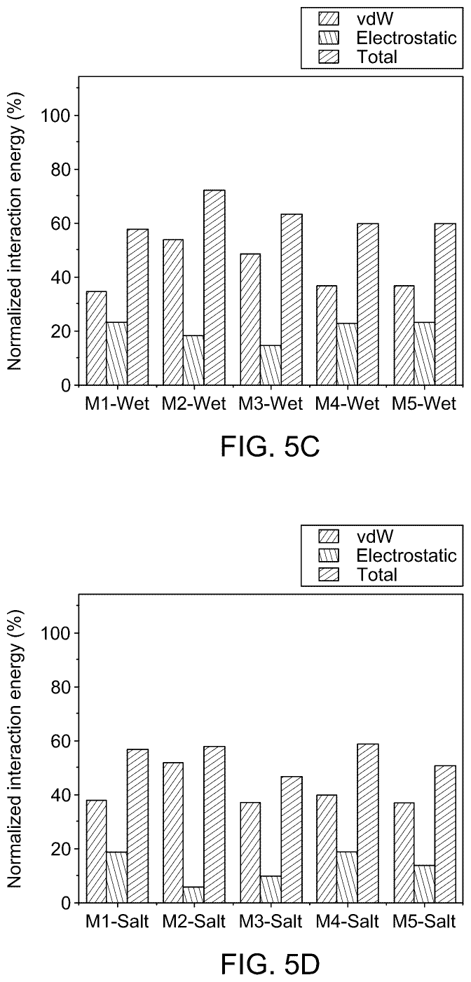

FIG. 5A shows the work of adhesion of all models. The adhesion energy values for the dry, wet, and salt systems were in the range of 236.5-333.5, 192.1-240.3, and 156.4-196.7 milliJoule per square metre (mJ/m²), respectively. These results showed that the adhesion energy was reduced by 26.4% and 35.9% on average at the wet and salt conditions when compared to the dry system. The more reduction associated with the NaCl solution might be attributed to the presence of aggressive species in the system. Regarding the effect of the graphene derivatives on the adhesion energy, it was found that the models M3 and M4 (M3 has a GO layer while M4 has a GR-modified epoxy) were performed well in the dry and pre-wetting systems. However, low adhesion energy was observed on the M3 conditioned by NaCl solution. The registered adhesion energy of M3 at dry, wet, and salt systems was 301.8, 210.1, 156.4 mJ/m², respectively, while these values in M4 were 333.5, 198.9, and 196.7 mJ/m².

Therefore, the results showed that the insertion of the GO layer is worked better than adding the GR layer to enhance the bonding energy between the C—S—H and epoxy. The reason behind this observation can be explained by the fact that the oxygen-containing functional groups in the GO layer provided more tight-binding patterns with the C—S—H surface and the epoxy overlay. On the other hand, the modification of the epoxy matrix by GR showed more improvement in the bonding properties of the epoxy composite. In fact, the GR incorporation into the epoxy matrix is suitably oriented inside the composite, while GO leads to forming an improper conformation of the composite as its negatively charged oxygen atoms are repulsive with the oxygen atoms of the epoxy itself. Thus, it can be proposed that the GR-mEP coating may be more effective in enhancing the interfacial properties of the EP/C—S—H system.

For more investigation on the source of the interactions among the interface of EP/C—S—H, the breakdown of the interaction energy, including electrostatic (Eₑₗₑ) and vdW (E_{vdW}) interactions were obtained. FIGS. 5B-5D show normalized interaction energy components of Eₑₗₑ and E_{vdW} for each model. The results showed that the electrostatic interactions were dominant at the dry system as they contributed to around 57.4% of the total interaction energy. However, the VanderWaals (vdW) interactions became the major contribution at the systems conditioned by moisture or NaCl solution as they formed around 67.5% and 75.3% of the total interaction energy, respectively. Therefore, the electrostatic energy may be the leading energy component in enhancing adhesion energy. The interactions among the epoxy/C—S—H have mainly come from electrostatic energy.

### Example 5: RDF Analysis

Interactions across the interface structures were studied using the radial distribution function (RDF) method. The RDF analysis measures the atomic bond length, which can be read from the horizontal ordinate value of the first prominent peak. The calculation formula for RDF is shown in Eq. (3).

$${g}_{AB} ( r ) = \frac{1}{{〈 {ρ}_{B} 〉}_{local}} \cdot \frac{1}{{N}_{A}} {\sum }_{i ∈ A}^{{N}_{A}} {\sum }_{i ∈ B}^{{N}_{B}} \frac{δ ( {r}_{ij} - r )}{4 π {r}^{2}} \qquad ( 3 )$$

where: g_{AB}(r) is the probability of finding particle B within the range around particle A; r represents the distance between each atom pair; N represents the number of atoms; and <ρ_{B}>_{local} is the density of B particle average overall shells around particle A. The RDF was calculated between the hydrogen atoms in the C—S—H surface (H_{CSH}) and oxygen atoms in epoxy (O_{EP}) in models M1, M4, and M5 after which the epoxy/C—S—H interface is present. FIGS. 6A-6B depict the RDF plots of the H_{CSH}—O_{EP}. As can be seen in FIGS. 6A-6B, identical sharp peaks appeared at distances of 1.95-2.05 Å, which fall within the range for forming the hydrogen bond connections (H-bond<2.45 Å). Thus, the oxygen atoms in the epoxy provide oxygen sites to accept the H-bonds from the hydrogen atoms in the water molecules or hydroxyl in the silicate tetrahedron of C—S—H, as shown in FIGS. 6A-6B.

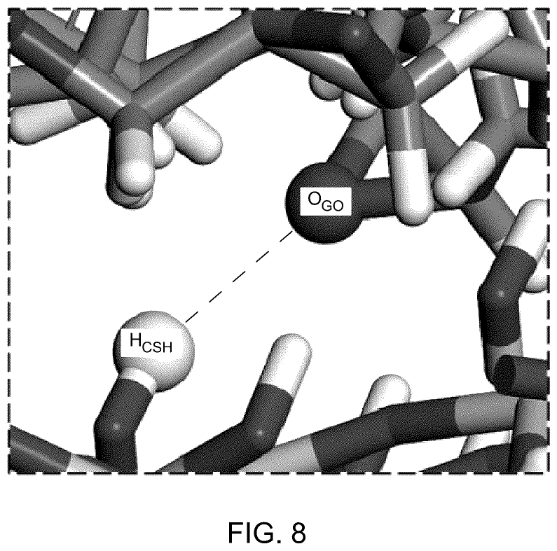

For models with GR or GO layer reinforcements (i.e., M2 and M3), the RDF analyses for H_{CSH}—C_{GR}, and H_{CSH}—C_{GO} (C_{GR} and C_{GO} represent the carbon atoms in GR and GO layers, respectively) were obtained, as shown in FIG. 7A and FIG. 7B, respectively. It was found that the peaks of H_{CSH}—C_{GR} pairs in the models M2-dry and M2-salt were located at 2.55 Å whereas the H_{CSH}—C_{GO} pairs displayed at 2.45 Å and 3.55 Å, respectively. In addition, the peak intensities of the dry models were larger than the counterpart salt models implying the NaCl solution reduced the connection and, thus, weakened the bonding between C—S—H and epoxy. Besides, the H_{CSH}-Oco pairs (O_{GO} represents the oxygen atoms of the functional groups in the GO layer) were also obtained, as shown in FIG. 7C and FIG. 8. The first peaks appeared at 1.85 Å and 1.95 Å in the models M3-dry and M3-salt, respectively. Therefore, the functional groups in the GO sheet can donate H-bonds to the C—S—H surface. Besides, the RDF curves at the epoxy and GO interface were obtained through O_{EP}—O_{GO} pairs, as displayed in FIG. 7D. The RDF peaks for models M3-dry formed at distances of 3.05 Å. Such strong connections between the epoxy molecules and the oxygen-containing functional groups on the GO layer are responsible for the high adhesion energy obtained in model M3. It was reported that the GO-epoxy interface possessed excellent bonding properties, which are associated with polar oxygen-containing functional groups on the GO sheet and the epoxy molecules [D. Hou, Q. Yang, Z. Jin, P. Wang, M. Wang, X. Wang, Y. Zhang, Enhancing interfacial bonding between epoxy and CSH using graphene oxide: An atomistic investigation, Appl. Surf. Sci. 568 (2021) 150896; and A. K. Pathak, M. Borah, A. Gupta, T. Yokozeki, S. R. Dhakate, Improved mechanical properties of carbon fiber/graphene oxide-epoxy hybrid composites, Compos. Sci. Technol. 135 (2016) 28-38, each of which is incorporated herein by reference in their entireties].

### Example 6: Concentration Analysis

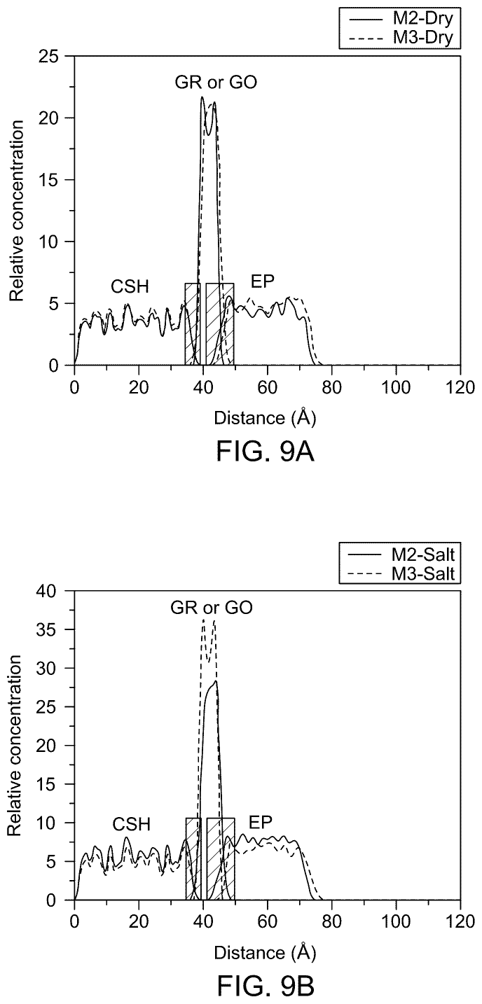

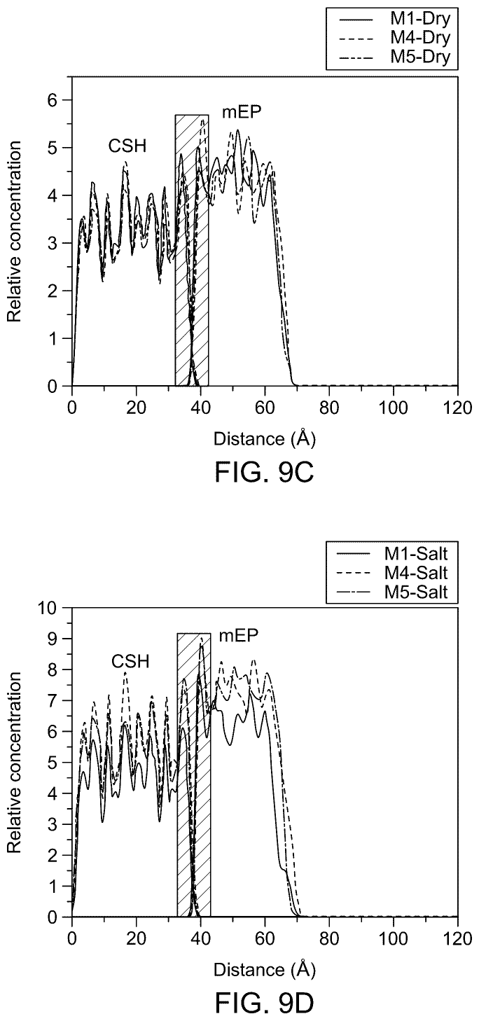

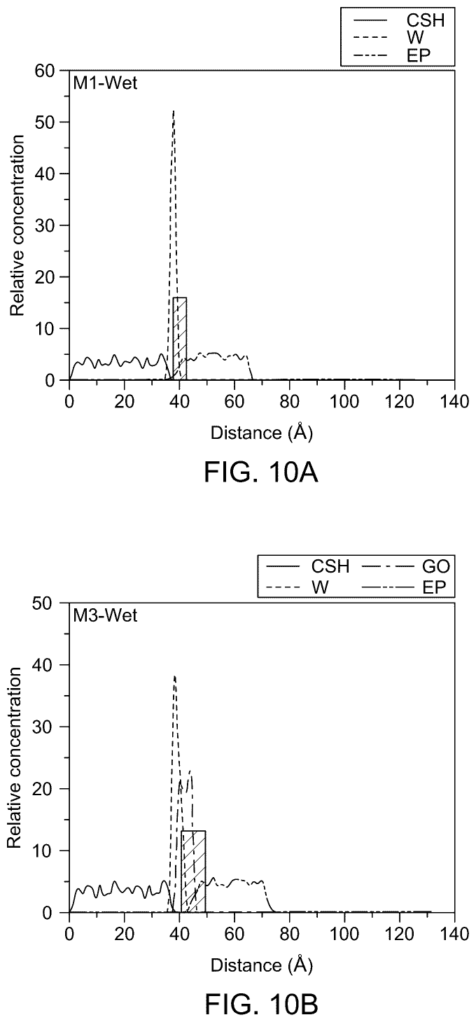

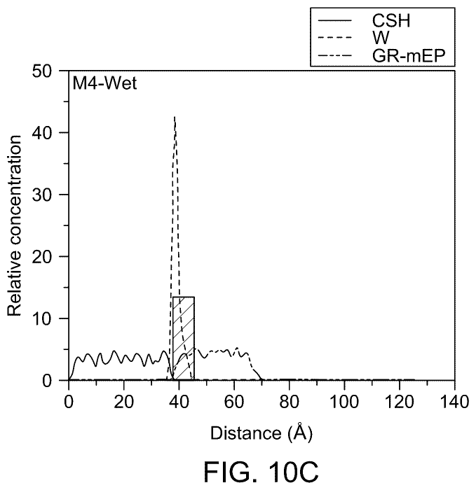

Information on the local structure of the interfaces can be obtained from the concentration distribution of the components (C—S—H, EP, mEP, GR, GO, or W). FIGS. 9A-9D are the intensity profile of each model. As can be seen in FIG. 9A and FIG. 9B that the GR or GO sheets were more attached to the epoxy molecules while they have relatively little contact with the C—S—H surface. It can be seen that the GO has an affinity with epoxy, and this could be explained through the strong connection between the functional groups on the GO sheet and the epoxy molecules. Therefore, the GO layer models exhibited more adhesion energy, as discussed before. The GR- or GO-modified epoxy models are also shown in FIG. 9C and FIG. 9D. Almost similar distributions were observed with an equal interphase region between the modified epoxy and C—S—H. However, M4 showed more intensity peaks implying the GR-mEP is tightly attached to the C—S—H substrate. The concentration profiles for the wet models (M1, M3, and M4) are depicted in FIGS. 10A-10C. The interfacial water molecules layer exhibited big peaks in all models. It can be observed that the water molecules in M3 had more affinity with the GO layer, and this could be attributed to the hydrophilic nature of the functional groups in the GO sheet. On the other hand, the less interphase region was noted between the water and epoxy molecules due to the hydrophobicity of epoxy. However, the GR-mEP (M4) model indicated a good contact between the epoxy and the substrate as the interphase region was more widened compared to the reference model with unmodified epoxy (M1). Therefore, it seemed the modified epoxy diminished the negative effect of the interfacial water molecules on the bonding of epoxy with the substrate.

### Example 7: Diffusion Mechanism of Water and Ions

The diffusion behavior of the particle's H₂O and Cl⁻ inside the models M1-M5 was studied. The trajectory conformations generated from the MD simulations were used to track the probes' migration across the models. The mean square displacement (MSD) of the particles was calculated using Eq. (4). Then, the diffusion coefficients (D) of corrosive particles were calculated according to the Einstein equation (Eq. 5)).

$$\begin{matrix}MSD = 〈 {\vert {r}_{i} ( t ) - {r}_{i} ( 0 ) \vert}^{2} 〉 & ( 4 ) \\ D = \frac{1}{6 N} {lim}_{t \to ∞} \frac{d}{dt} {\sum }_{i = 1}^{N} 〈 {\vert {r}_{i} ( t ) - {r}_{i} ( 0 ) \vert}^{2} 〉 & ( 5 )\end{matrix}$$

where: N is the total number of particles to be averaged; and rᵢ(t) and rᵢ(0) represent the position of a particle i at time t and initial time, respectively.

FIGS. 11A-11B depict the MSD curves of H₂O and Cl-particles. The MSD increased with the increase of time. The migration paths of H₂O molecules appeared to be linear in all models, while the plots of Cl-behaved in a little randomness. However, the movement trend of the particles in all models was almost identical, which is in the following decreasing order: M1>M5>M2>M3>M4. Thus, model M1, the reference model without any graphene reinforcement, showed the highest MSD values compared to the others. On the other hand, the models M3 and M4 exhibited the lowest MSD values. Although the model M3 had low adhesion energy between the surface and epoxy, it showed a good inhibition performance against the ingress of the aggressive species. This discrepancy highlighted that the influence of NaCl solution in the adhesion energy might have a different mechanism. In addition, the diffusion coefficient (D) of H₂O and Cl⁻ are calculated, as presented in

TABLE 1
Table 1. Diffusion coefficients (D)
of the water molecules and Cl— ions.

D (×10⁻¹² m² · s⁻¹)

| Model | H₂O | Cl⁻ |
|---|---|---|
| M1 | 0.087 | 0.127 |
| M2 | 0.069 | 0.076 |
| M3 | 0.060 | 0.053 |
| M4 | 0.053 | 0.041 |
| M5 | 0.087 | 0.069 |

The D values of H₂O and Cl⁻ for M1 were found to be 0.087 and 0.127×10⁻¹² m²·s⁻¹ respectively, while for model M4, they were 0.053 and 0.041×10⁻¹² m²·s⁻¹. This corresponded to a reduction by 39.4% and 67.5% in the diffusion coefficient of particles H₂O and Cl⁻ when the graphene reinforcement was used. Therefore, the adopted graphene reinforcement method effectively mitigates the diffusion of aggressive species, which will improve the durability of the epoxy/concrete interface.

The capillary transport mechanism of water molecules and ions was more investigated through the penetration depth. FIGS. 12A-12B show the penetration depth curves with time for H₂O molecules and Cl⁻ ions. The traveling of H₂O molecules followed a rising parabolic path while the migration of the Cl⁻ ions started in a proportional trend and then tended to be almost constant, especially in models M3-4. The results suggested that the models M3 and M4 exhibited the lowest penetration behavior of the water and ions among the other models. It was found that the penetration depths of H₂O and Cl⁻ in M3 were 168.7 Å and 177.7 Å, respectively, at the end of simulation time. These values in M1 corresponded to 236.5 Å and 294.4 Å (i.e., a reduction of 40.2% and 65.7% in the transport of H₂O and Cl⁻). Similarly, the penetration depths of H₂O and Cl⁻ in M4 were significantly reduced by 48% and 191%, respectively. This highlighted the inhibition mechanism of the model with the graphene-modified epoxy. Besides, the resistance of the graphene-modified epoxy against the aggressive ions (i.e., NaCl environment) was better than its water resistance. Such behavior was also reported where the graphene-epoxy composite showed a slow transport of the Na+ and Cl⁻ ions compared to the water molecules. A possible reason behind this is the formation of an ionic hydration shell in which the ions are carried by water molecules.

To summarize, the utilization of graphene-based nanomaterials to improve the adhesion properties of the epoxy/hydrated cement is investigated for their applications in the construction industry. However, their bonding performance with the concrete substrate may be affected by the aggressive environments which may lead to trigger a failure of the bonded systems. The presence of the pre-wetting surface and NaCl solution reduced the adhesion energy by 26.4% and 35.9%, respectively, compared to the dry system. Two reinforcement schemes including adding a GO layer between the C—S—H and epoxy and applying the GR-modified epoxy are disclosed. In addition, it was found that the electrostatic interactions were dominant at the dry system, whereas at the systems conditioned by moisture or NaCl solution, the interactions among the epoxy/C—S—H mainly came from the van der Waals Interactions. The RDF analysis of the models having the epoxy/C—S—H interface showed that hydrogen bond connections were formed between the hydrogen atoms in the C—S—H surface and oxygen atoms in epoxy (H_{CSH}—O_{EP}) where the first peaks appeared at a distance of 1.95-2.05 Å. In addition, for the models with the GO layer, strong connections between the epoxy molecules and the oxygen-containing functional groups on the GO layer were found, which are responsible for the improved adhesion energy. The intensity analysis of the models' components revealed that the GO has a close affinity with epoxy while the models with GR-modified epoxy were tightly attached to the C—S—H substrate. In addition, the models conditioned with pre-wetting surface showed a close affinity between the water molecules and GO layer, and this could be attributed to the hydrophilic nature of the functional groups in the GO sheet while less interphase region was observed between the water and epoxy molecules due to the hydrophobicity of epoxy. The diffusion results of the models subjected to NaCl environment exhibited that the GR-modified epoxy mitigated the migration of the H₂O molecule and Cl⁻ ions (diffusion coefficient reduced by 39.4% and 67.5%, respectively).

Numerous modifications and variations of the present disclosure are possible in light of the above teachings. It is therefore to be understood that within the scope of the appended claims, the invention may be practiced otherwise than as specifically described herein.

1: A method for enhancing adhesion of a curable composition to a cement-based object, comprising:
applying a graphene oxide (GO) containing dispersion on a surface of the cement-based object thereby forming a GO-treated surface on the cement-based object;
disposing the curable composition on the GO-treated surface of the cement-based object; and
curing the curable composition by heating thereby forming a GO interfacial layer and an epoxy resin layer;
wherein the GO interfacial layer is between the surface of the cement-based object and the epoxy resin layer;
wherein the curable composition comprises an epoxy monomer and an amine curing agent; and
wherein the GO interfacial layer has a thickness of from 0.1 to 10 nanometers (nm).

2: The method of claim 1, wherein the GO interfacial layer has a thickness of 0.2 to 2 nm.

3: The method of claim 1, wherein the GO interfacial layer has an oxygen coverage of 10 to 40% based on a total number of carbon atoms.

4: The method of claim 1, wherein the GO interfacial layer comprises GO particles having one or more functional groups selected from the group consisting of epoxide (—O—), hydroxyl (—OH), and carboxyl (—COOH); and wherein the cement-based object comprises hydrated calcium silicate (C—S—H) particles having one or more hydroxyl (—OH) groups.

5: The method of claim 4, wherein one or more hydrogen atoms in the hydroxyl groups of the hydrated calcium silicate (H_{CSH}) particles interact with one or more oxygen atoms of the epoxy resin layer (O_{EP}) and the GO interfacial layer (O_{GO}) resulting in the formation of one or more H_{CSH}—O_{EP} bonds and one or more H_{CSH}—O_{GO} bond.

6: The method of claim 5, wherein the one or more H_{CSH}—O_{EP} bonds have an average length of 1.95 to 2.05 angstroms (Å).

7: The method of claim 5, wherein the one or more H_{CSH}—O_{GO} bonds have an average length of 1.8 to 1.95 Å.

8: The method of claim 4, wherein one or more hydrogen atoms in the hydroxyl groups of the hydrated calcium silicate (H_{CSH}) particles interact with one or more carbon atoms of the GO interfacial layer (C_{GO}) resulting in the formation of one or more H_{CSH}—C_{GO} bonds.

9: The method of claim 8, wherein the one or more H_{CSH}—C_{GO} bonds have an average length of 3.5 to 3.6 Å.

10: The method of claim 4, wherein one or more oxygen atoms of the epoxy resin layer (O_{EP}) interact with one or more oxygen atoms of the GO interfacial layer (O_{GO}) resulting in the formation of one or more O_{EP}—O_{GO} bonds.

11: The method of claim 10, wherein the one or more O_{EP}—O_{GO} bonds have an average length of 3 to 3.1 Å.

12: The method of claim 1, wherein a mole ratio of the epoxy monomer to the amine curing agent is in a range of 5:1 to 1:1.

13: The method of claim 1, wherein after the curing the epoxy resin of the epoxy resin layer has a cross-linking degree of 60 to 95% based on a total number of the epoxy monomer and the amine curing agent.

14: The method of claim 1, wherein the epoxy monomer is a polyhydric phenol glycidyl ether, and wherein the polyhydric phenol glycidyl ether comprises diglycidyl ether bisphenol-A (DGEBA).

15: The method of claim 1, wherein the amine curing agent is a phenylenediamine, and wherein the phenylenediamine comprises m-phenylenediamine (m-PDA).

16: The method of claim 1, wherein a weight ratio of the GO interfacial layer to the epoxy resin layer is in a range of 1:200 to 1:10.

17: The method of claim 1, wherein the adhesion of the epoxy resin layer formed from the curable composition to the cement-based object is improved compared to that of an epoxy resin layer formed from a composition in the absence of the GO when exposed to a condition selected from the group consisting of a dry condition, a wet condition, and a salt-containing condition, wherein the epoxy resin layer has a water diffusion coefficient of 0.05×10⁻¹² to 0.09×10⁻¹² meter square per second (m²·s⁻¹), and wherein the epoxy resin layer has a chloride ions diffusion coefficient of 0.04×10⁻¹² to 0.13×10⁻¹² m²·s⁻¹.

18: A method for enhancing adhesion of a graphene (GR) containing composition to a cement-based object, comprising:
mixing an epoxy monomer, an amine curing agent, and a GR nanomaterial to form the GR-containing composition;
disposing the GR-containing composition on a surface of the cement-based object; and
curing the GR-containing composition by heating thereby forming a modified epoxy resin layer on the surface of the cement-based object; and
wherein the GR nanomaterial has a thickness of 0.2 to 1 nm; and
wherein the GR nanomaterial is present in the GR-containing composition at a concentration of 0.01 to 10 wt. % by weight.

19: The method of claim 18, wherein one or more hydrogen atoms in the hydroxyl groups of the hydrated calcium silicate (H_{CSH}) particles of the cement-based object interact with one or more carbon atoms of the GR nanomaterial in the modified epoxy resin (C_{GR}) resulting in the formation of one or more H_{CSH}—C_{GR} bonds.

20: The method of claim 19, wherein the one or more H_{CSH}—C_{GR} bonds have an average length of 2.5 to 2.6 Å.
